(19) United States
(12) Patent Application Publication
(10) Pub. No.: US 2025/0103994 A1
(43) Pub. Date: Mar. 27, 2025

(54) METHOD AND SYSTEM OF ANALYZING ENTERPRISE-TO-ENTERPRISE CONNECTIONS

(71) Applicant: Microsoft Technology Licensing, LLC, Redmond, WA (US)

(72) Inventors: Qintian ZHANG, Seattle, WA (US); Choo Yei CHONG, Redmond, WA (US); Catherine Kursch BOEGER, Kirkland, WA (US); Matthew Bradley ONTELL, Richmond, VA (US)

(73) Assignee: Microsoft Technology Licensing, LLC, Redmond, WA (US)

(21) Appl. No.: 18/473,988

(22) Filed: Sep. 25, 2023

(51) Int. Cl. G06Q 10/0639

(52) U.S. Cl. CPC G06Q 10/06395

(57) ABSTRACT

A system and method for analyzing connections between a first enterprise and a second enterprise includes retrieving connection data related to connections between the first enterprise and the second enterprise from a plurality of data sources and utilizing a connection graph generating engine to generate a connection graph for the connections between the first enterprise and the second enterprise, where the connection graph is generated based on the retrieved connection data. The connection graph is provided as an input to a trained machine-learning (ML) model to identify connection patterns in the connections between the first enterprise and the second enterprise and recommendations are generated using a second trained ML model based on the identified connection patterns and based on at least one of a context of the first enterprise or the second enterprise. The recommendations are provided for display to a user.

### BACKGROUND

Enterprises often have many employees or other individuals associated with the enterprise that correspond with or otherwise have connections with individuals in other enterprises. In today's digital communication environment, there are many different ways in which individuals can communicate or make connection with other people. Because of the numerous ways in which people can make connections and communicate with others, and because the platforms used for communications are not always connected or easily accessible to all parties, it is often very challenging for an enterprise to keep track of how their employees are connected to people outside of their enterprise. While there are some technologies that identify person-to-person connections within an enterprise, there are currently no mechanisms for accurately and efficiently analyzing connections or relationships between individuals in one organization and another organization. However, assessing relationships with other enterprises is often important in determining how to improve technology and/or relationships.

Hence, there is a need for improved systems and methods of analyzing enterprise-to-enterprise connections.

### SUMMARY

In one general aspect, the instant disclosure presents a data processing system having a processor and a memory in communication with the processor wherein the memory stores executable instructions that, when executed by the processor, cause the data processing system to perform multiple functions. The function may include aggregating connection data from a plurality of data sources, the connection data being related to connections between a first enterprise and a second enterprise; utilizing a connection graph generating engine to generate a connection graph for the connections between the first enterprise and the second enterprise, the connection graph being generated based on the aggregated connection data; providing the connection graph as an input to a first trained machine-learning (ML) model to identify connection patterns in the connections between the first enterprise and the second enterprise; generating recommendations using a second trained ML model based on the identified connection patterns and based on at least one of a context of the first enterprise and a context of the second enterprise; and providing the recommendations for display to a user.

In yet another general aspect, the instant disclosure presents a method for analyzing connections between a first enterprise and a second enterprise. In some implementations, the method includes retrieving connection data related to connections between the first enterprise and the second enterprise from a plurality of data sources; utilizing a connection graph generating engine to generate a connection graph for the connections between the first enterprise and the second enterprise, the connection graph being generated based on the retrieved connection data; providing the connection graph as an input to a first trained ML model to identify connection patterns in the connections between the first enterprise and the second enterprise; generate recommendations using a second trained ML model based on the identified connection patterns and based on at least one of a context of the first enterprise and a context of the second enterprise; and providing the recommendations for display to a user.

In a further general aspect, the instant application describes a non-transitory computer readable medium on which are stored instructions that when executed cause a programmable device to perform functions of aggregating connection data from a plurality of data sources, the connection data being related to connections between a first enterprise and a second enterprise; utilizing a connection graph generating engine to generate a connection graph for the connections between the first enterprise and the second enterprise, the connection graph being generated based on the aggregated connection data; providing the connection graph as an input to a first trained ML model to identify connection patterns in the connections between the first enterprise and the second enterprise; training a second ML model to generate recommendations for improving the connections between the first enterprise and the second enterprise based on connection patterns between the first enterprise and the second enterprise; utilizing the second trained ML model to generate the recommendations based on the identified connection patterns and based on at least one of a context of the first enterprise and a context of the second enterprise.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts some elements involved in analyzing enterprise-to-enterprise connections.

FIG. 3 depicts how one or more machine-learning (ML) models used in analyzing enterprise-to-enterprise connections and providing recommendations are trained.

FIGS. 4A-4D depict example GUI screens of an application or service that offers review and analysis of enterprise-to-enterprise connections and/or recommendations for improving enterprise-to-enterprise connections.

FIG. 5 is a flow diagram depicting an example method for analyzing connections between two enterprises and providing recommendations based on the analysis.

FIG. 6 is a block diagram illustrating an example software architecture, various portions of which may be used in conjunction with various hardware architectures herein described.

FIG. 7 is a block diagram illustrating components of an example machine configured to read instructions from a machine-readable medium and perform any of the features described herein.

### DETAILED DESCRIPTION

Connections between individuals and different enterprises is often considered a valuable asset which can be used to derive innovation, partnerships, collaboration and the like. In today's digital environment where many avenues for communication and connection are present, people use different methods of communication to make connections with each other. In order to examine, make use of and improve internal communications and/or relationships, some mechanisms have been generated that analyze connections/relationships between individual users or connections/relationships between different teams in an organization. While such tools are useful in gaining insights about internal company connections, they cannot be used to analyze connections between organizations. That is because external communications are often more complex and harder to keep track of. Furthermore, understanding connections with external enterprises often requires an understanding of the external organization's departments, teams, employee hierarchy and the like. This information is often not available to an external organization. Thus, currently available analytical tools for analyzing enterprise connections cannot be used to provide analysis on enterprise level external communications. Thus, there exists a technical problem of lack of mechanisms for identifying trends and important communications or connection patterns between two entities. This results in inefficient communications between organizations, insufficient connections and/or wasteful use of computer resources in establishing connections between two organizations.

To address these technical problems and more, in an example, this description provides technical solutions for identifying connections between individuals in one enterprise and individuals in another enterprise, analyzing the connections to create a connection graph and utilizing the connection graph to make recommendations to one or more individuals in one of the two enterprises. The recommendations may take into account the context of each enterprise. For example, the recommendations may be based on goals and objectives of the enterprise or individual receiving the recommendations. In some implementations, the recommendations are provided by trained machine-learning models that are trained to generate recommendations and action items based on enterprise-to-enterprise connections and/or goals of the enterprise. Thus, the technical solution offers an enterprise network graph analytical tool that identifies trends and important communication patterns between two enterprises by analyzing network graph of one enterprise's users' communication, calendar, social network, and/or other data with users of another enterprise. The technical solutions provides algorithms, models and/or processes for identifying the important patterns and trends. Examples of important patterns and findings include connections between the enterprises resting on a few key individuals, a user being a second-degree connection to key relations, a user developing deeper connection with an enterprise and the like. Once the findings are determined, mechanism are used to automatically identify recommended actions based on the identified patterns and trends. Examples of recommended actions include retention and/or promotion of key individual users, designating relationship champions, hiring from the other enterprise, development of a project in early stages and the like.

In this manner, the technical solution described herein addresses the technical problem of lack of mechanisms for accurately and efficiently identifying enterprise-to-enterprise connections and relationships, and lack of mechanisms for automatically identifying recommendations based on such relationships. The technical solution utilizes a system that retrieves data from a plurality of diverse data sources, automatically aggregates and analyzes the data to accurately identify enterprise-to-enterprise connections, and automatically identifies recommendations based on those connections. This provides the technical advantage of more efficient computation and use of computing resources, such as memory and processor resources, for analyzing communication data and connection data between two enterprises, thus resulting in reduction in computing resources and memory required for such computations. The technical effects at least include (1) improving the operation of computing systems and software programs by retrieving data from diverse data sources and automatically aggregating the data; (2) improving accuracy and efficiency of identifying enterprise-to-enterprise connections; (3) automatically providing recommendations based on identified enterprise-to-enterprise connections; and (4) providing user interface (UI) elements that enable a user to efficiently review enterprise-to-enterprise connections and receive recommendations to improve connections or relationships.

As used herein, the terms “enterprise,” or “organization” refers to a company, institute (e.g., an educational institute or non-profit organization), business or other organized body of a people with a particular purpose. The term “connection” refers to any communication or interaction between two or more individuals. The term “relationship” refers to a connection or any other form of interaction between two or more individuals.

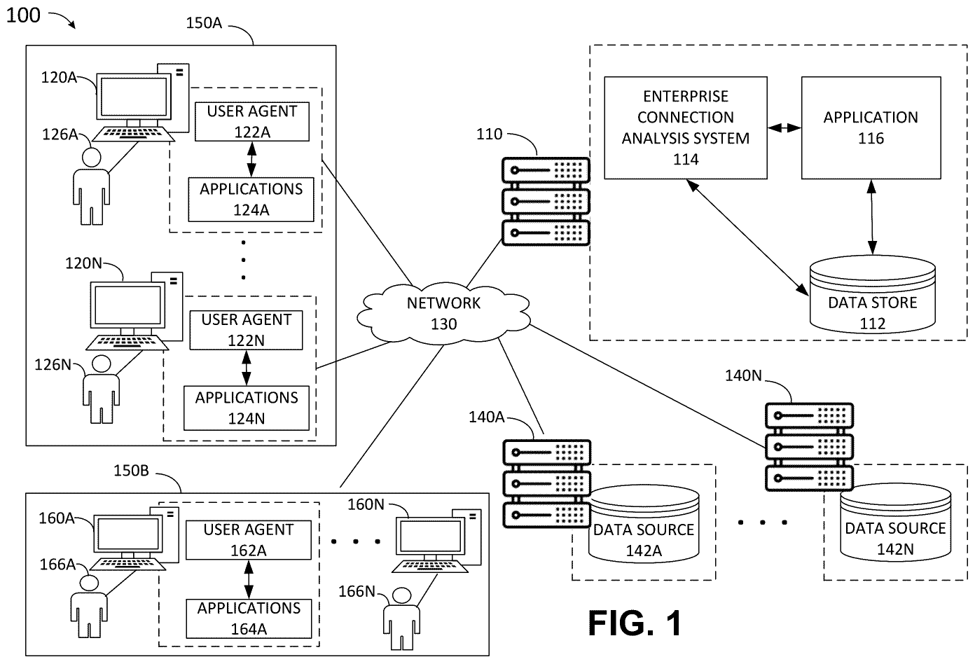

FIG. 1 illustrates an example system 100, upon which aspects of this disclosure may be implemented. The system 100 includes a server 110 which is connected to or includes an enterprise connection analysis system 114, a data store 112, and an application 116. The server 110 may include a plurality of servers that work together to deliver the functions and services provided by each service or application. The server 110 may operate as a cloud-based server for offering enterprises connection analysis services. The services offered by the enterprise connection analysis system 114 may be offered in one or more applications such as application 116 and/or applications 124. In some implementations, server 110 operates as a shared resource server located at an enterprise accessible by various computer client devices such as one or more of the client devices 120A-120N (referred to collectively and/or individually, for ease of reference, as client device 120) or client devices 160A-160N (referred to collectively and/or individually, for ease of reference, as client device 160).

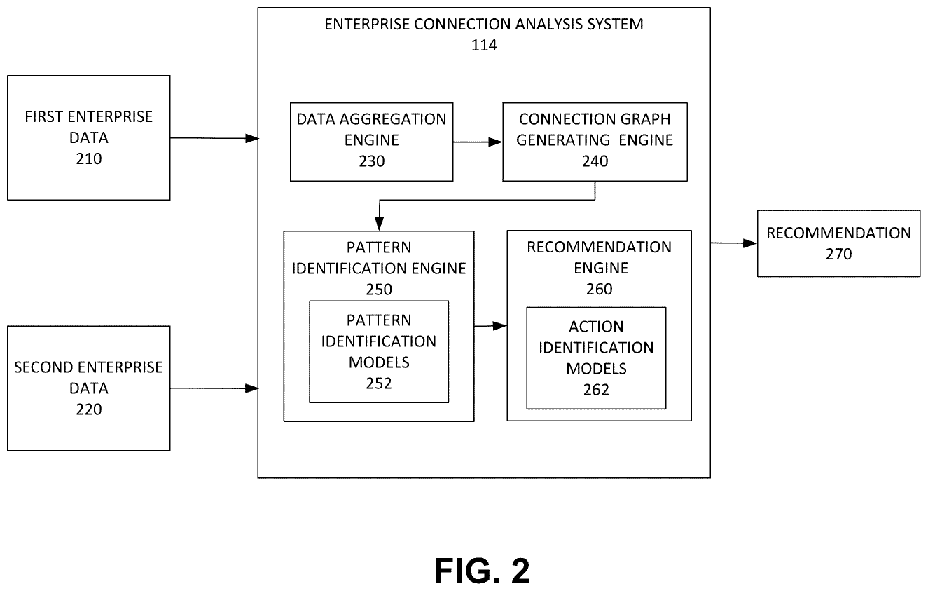

The enterprise connection analysis system 114 provides analysis of connections between users of two or more different enterprises to identify patterns of communications or patterns in relationships that are used to provide recommendations. The enterprise connection analysis system 114 retrieves data from one or diverse data sources such as the data sources 142A-142N (referred to collectively and/or individually, for ease of reference, as data source 142), preprocesses the received data, when needed, aggregates the data, and uses artificial intelligence to generate a connection graph depicting connections between individual users of one enterprise and individual users of another enterprise. The enterprise connection analysis system 114 then analyzes the connection graph to identify patterns in communication and/or connections overtime. Based on the connection graph and/or the identified patterns, the enterprise connection analysis system 114 generates and transmits recommendations for improving connections and/or achieving enterprise objectives. The recommendations may be provided to users via the application 116, applications 124 or applications 164. Various elements of the enterprise connection analysis system 114 are discussed in more detail with respect to FIG. 2.

The data store 112 functions as a repository in which the retrieved connection data, aggregated data, connection graph data, data related to the identified patterns and/or data related to the recommendations, and the like may be stored. Although shown as a single data store, the data store 112 may be representative of multiple storage devices and data stores which may be connected to each of the various elements of the system 100. Furthermore, although the data store 112 is shown as being part of the server 110, one or more elements (e.g., storage mediums) of the data store 112 may be provided in separate storage servers or other types of servers.

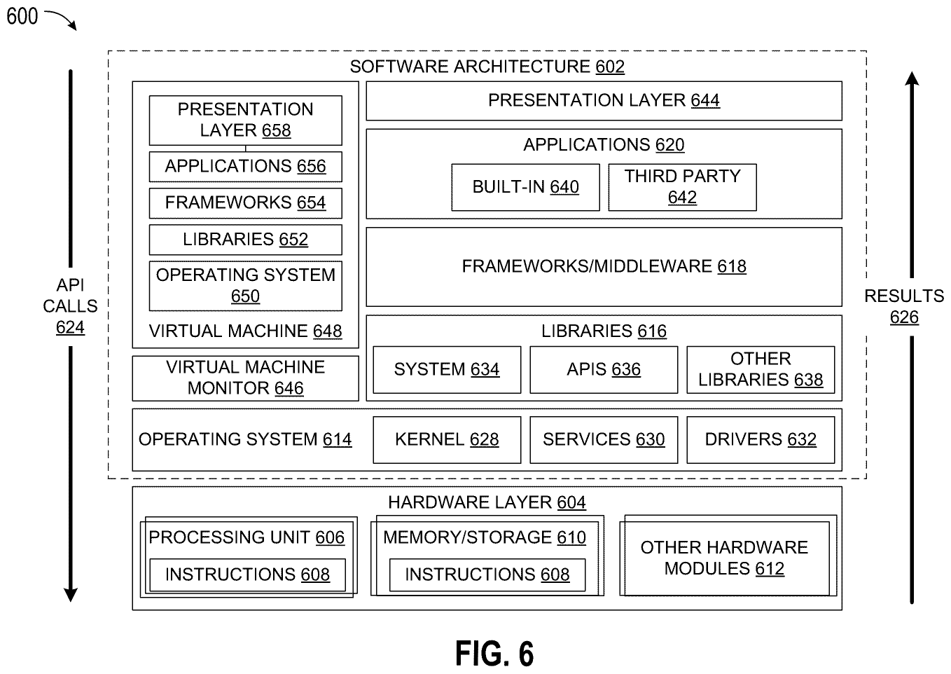

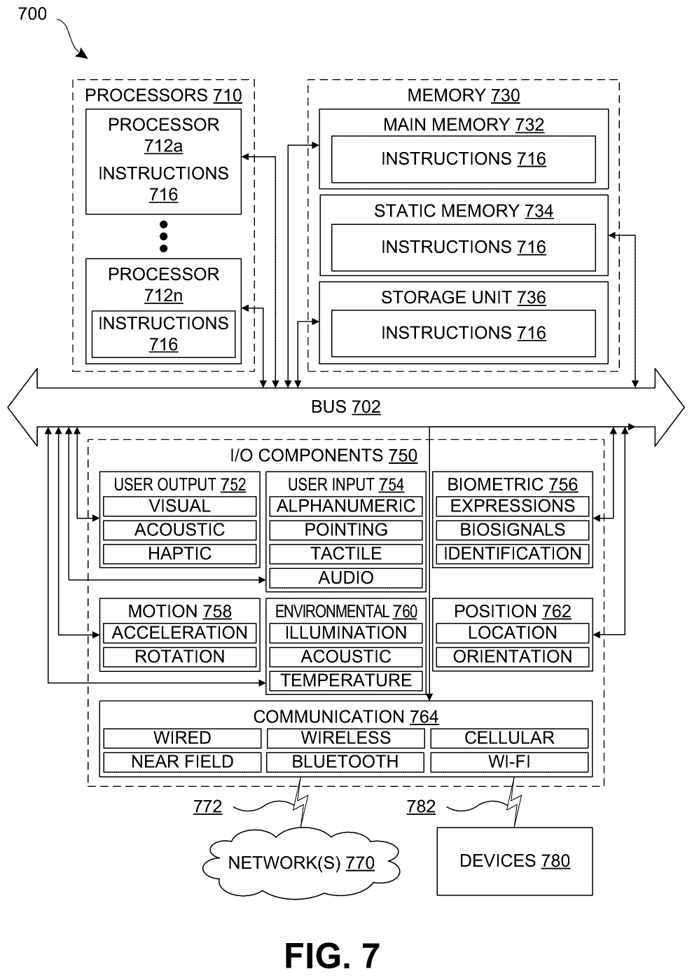

Each of the client devices 120A-120N and 160A-160N may be connected to the server 110 via a network 130. The network 130 may be a wired or wireless network(s) or a combination of wired and wireless networks that connect one or more elements of the system 100. The client devices 120A-120N and 160A-160N may be personal or handheld computing device having or being connected to input/output elements that enable a user to interact with various applications and (e.g., application 116, applications 124A-124N or applications 164A). Examples of suitable client devices 120A-120N and 160A-160N include but are not limited to personal computers, desktop computers, laptop computers, mobile telephones, smart phones, tablets, phablets, smart watches, wearable computers, gaming devices/computers, televisions, and the like. Client devices 120A-120N represent client devices associated with a first enterprise 150A, while client devices 160A-160N represent client devices associated with a second enterprise 150B. While two enterprises are shown in FIG. 1, more than two enterprises may be presented in other implementations. The internal hardware structure of a client device is discussed in greater detail in regard to FIGS. 6 and 7.

Each of the client devices 120A-120N and 160A-160N may be associated with a different user such as users 126A-126N (referred to collectively as user 126) and users 166A-166N. In some implementations, a client device 120 or 160 is associated with a user 126 or user 166 who may be a team leader or a manager responsible for making business or human resources decisions. The user 126 and/or 166 may utilize an application such as online application 116 or local applications 124 or 164A (although no application is shown for client device 160N in FIG. 1, other client devices in the enterprise 150B also include applications such as application 164A) to review enterprise-to-enterprise connection graphs, connection data and/or recommendations generated based on the connection information. In some implementations, recommendations are provided to the user 126 and/or user 166 via the online application 116 or local applications 124/164A. For example, the online application 116 or local applications 124/164A may provide a user interface screen (e.g., a portal) that displays recommendations or action items based on the analyzed connection information.

The application 124/164A and/or 116 also represent applications used by users for connecting with users in another enterprise. For example, applications 124 and/or application 116 may be any application that provides a communication channel via which the user 126 can make connection with the user 166. Such communications include messages (e.g., email messages, instant messages, voice messages and the like), social media interactions (commenting on a post by the other use, liking a post by the other use, etc.), attending the same meeting, voice or video calls, editing or reviewing the same document (e.g., commenting on a document authored by another user) and the like. As such applications 124/164A and/or application 116 may be communication applications (e.g., email application, virtual meeting application, instant messaging application), calendar application, social media application, productively application (e.g., word processing application, presentation application, etc.) and the like. Applications 124A-124N and 164A are native applications that are installed on one of the client devices 120 or 160. Application 116 represents similar applications that are executed on the server 110 (and are provided via an online service. In some implementations, web applications communicate via the network 130 with a user agent 122A-122N and/or 162A, such as a browser, executing on the client device 120 and/or 160. The user agent 122A-122N and/or 162A may provide a UI that allows the user to interact with application 116 and may enable application 116 to provide data to or receive data from the enterprise connection analysis system 114.

The storage servers 140A-140N (referred to collectively and/or individually, for ease of reference, as client device 140) store one or more data sources 142A-142N for storing enterprise connection data. In some implementations, connection data related to different types of applications are stored in different data stores and/or data structures (e.g., email messages are stored in a different data store than meeting data). Examples of types of data stored in the data sources 142A-142N include email data, professional network data (e.g., LinkedIn), enterprise graph data (e.g., employee data from an organization) and the like. Furthermore, data associated with different enterprises may be stored in different data sources or data stores. For example, enterprise connection data for enterprise 150A is stored in a different data source 140 than enterprise connection data for enterprise 150B.

FIG. 2 depicts some elements involved in analyzing enterprise-to-enterprise connections. In some implementations, the enterprise connection analysis system 114 retrieves first enterprise data 210 and second enterprise data 220 for processing. The first enterprise data 210 and second enterprise data 220 data may be retrieved from one or more data storage mediums that store enterprise data such as the data sources 142. The data storage mediums can include storage mediums accessible via a network (e.g., cloud storage) and/or open-source data sources (e.g., LinkedIn or news sources). In some implementations, the first enterprise data 210 is stored in a different data source than the second enterprise data 220. In some implementation, the first enterprise data 210 includes data related to communication, events (e.g., calendar data) and/or relationships between users of the first enterprise and users of the second enterprise. The first enterprise data 210 may include data from a variety of data sources. The data may be derived from different types of applications and/or communication platforms. In some implementations, data from given time periods is retrieved from one or more users associated with the first enterprise. In an example, data is only retrieved for a subset of users associated with an organization (e.g., users associated with a specific department such as the sales department or users having specific roles such as management titles). The types of data and the number of type of users for which data is retrieved may depend on the type of enterprise and/or objectives of the enterprise.

In some implementations, the types of data retrieved depends on the data source from which data is collected. In an example, data from an application that provides professional networking (e.g., LinkedIn®) is retrieved by using a bot or other automated agent that connects with users (e.g., users who opt-in to a feature). The bot can then retrieve a list of individuals the users of the first organization who opted into the feature are connected with (e.g., via a 1^{st} connection or via 2^{nd} and 3^{rd} degree connections). In another example, communications data such as email messages and/or contact groups are retrieved. In yet another example, calendar data or virtual meeting data is retrieved from a calendar application and/or virtual meeting application to detect meetings. In some cases, organization chart data is retrieved from internal organization graph data or from other data sources that provide such information. In other instances, event data is retrieved from event registration data and the like.

In some implementation, in addition to retrieving the first enterprise data 210, the enterprise connection analysis system 114 also retrieves second enterprise data 220 in order to better analyze the connections between the first enterprise and the second enterprise. This may be achieved by accessing publicly available data (e.g., data from the enterprise's website regarding their team members, departments and/or their employee hierarchy), data available to employees of the first organization regarding the second organization (e.g., career data available via a professional network application such as LinkedIn®). In some implementations, employment data about the employees of the second organization is retrieved from a professional network application such as LinkedIn. Retrieving this specific second enterprise data enables the enterprise connection analysis system 114 to more effectively analyze the connections between the first organization and the second organization. This also provides the technical advantage of enabling the enterprise connection analysis system 114 to provide recommendations that are tailored to the context of both the first organization and the second organization.

Once the first enterprise data 210 and second enterprise data 220 have been retrieved, the enterprise connection analysis system 114 utilizes a data aggregation engine 230 to aggregate the retrieved data. Aggregation may include preprocessing such as converting some of the data to ensure all the data has the same schema. Normalizing the data ensures that the data is converted to a standard schema so it can be compared/processed more efficiently. Aggregating the data also involves identifying inside and/or outside groups. An inside group refers to a group of users associated with the first enterprise (e.g., employees of the first enterprise) who are grouped together in the same team based on one or more parameters. The groups may be predetermined. For example, groups may be based on departments in the organization (e.g., sales department, engineering department, etc.) or may be based on employee teams (e.g., people who report to the same manager). In some implementations, the data aggregation engine 230 identifies the inside groups based on the retrieved data and based on a clustering pattern of relationships. This may be achieved by utilizing one or more clustering patterns that examine the first enterprise data and cluster the users based on the extent of their connections and/or relationships with each other and/or based on other organizational data. An outside group refers to a group of users with the second enterprise (e.g., employees of the second enterprise) who are grouped together in the same team based on one or more parameters. Because less information may be accessible about the second organization, outside groups may be generated based on more generalized information. For example, the data aggregation engine 230 may create the outside groups by using email addresses or another known form of ID as identifiers for the users of the second organization and group the users based on domain name in the email address or another identifier that identifies the organization with which they are associated. This would generate large outside groups, which can be further enhanced by dividing the large outside group into smaller groups based on publicly available data (e.g., LinkedIn data or website data). For example, once the outside group identifies all known employees of the second organization, the data aggregation engine 230 may collect data for the known employees from their publicly available professional profiles. For example, when a publicly available (or in other ways available to the enterprise connection analysis system) professional profile for an employee of enterprise XYZ indicates the employee is a product manager in the XYZ company's office in San Jose, the data aggregation engine 230 may collect this information to create an outside group of enterprise XYZ employees in San Jose or an outside group of product managers at enterprise XYZ. Generating inside and/or outside groups may involve the use of one or more ML models. In some implementations, an outgroup is defined by a user. For example, a requesting user may request data about connections between employees of the first enterprise and a specific group of users in the second enterprise. Such a request may include a list of users in the second enterprise the requesting user is interested in.

Once the inside and outside groups have been identified, data related to connections between users of the inside groups and outside groups may be collected, if the data has not already been retrieved. In some implementations, data about internal connection is also collected. The internal connection data may be used to examine how connections between inside groups or team members within inside groups are related to internal-external connections. For example, examining the internal connection may reveal that multiple employees in the same team are connecting with the same external individual, resulting in decentralization and/or redundancy. In another example, examining the internal connections reveals that each internal group member is connected to a different external employee, resulting in redundancy. To identify these types of patterns, internal connection data is collected and/or generated through internal directory or other data sources. The collected data along with the information about the inside groups and outside groups may be transmitted to the connection graph generating engine 240 to generate a connection graph between the users of the first enterprise and the users of the second enterprise. In some implementations, the connection graph is for connections between the inside groups and the outside groups. To generate the connection graph, the connection graph generating engine 240 may use known connection graph generating mechanisms (e.g., ML models) that analyze the relationships between each inside group and outside group to generate the connection graph. Relationships (edges between nodes) are identified when users from an inside group are engaged with users of an outside group. Engagement includes exchanging messages such as email messages, attending the same meetings, attending the same conferences, interacting on posts (e.g., social meeting posts, meeting notes, etc.), and the like.

After the connection graph is generated, it is provided to the pattern identification engine 250 for analysis. The pattern identification engine 250 analyzes the connections between the inside groups and the outside groups to identify patterns, important information, risks, opportunities for improving relationships and the like. In some implementations, this involves identifying weak connections between the inside groups and outside groups, detecting sparsity of connection between the inside groups and outside groups, identifying alternative paths to reaching a person in an outside group, and identifying redundancy/double-teaming in order to improve organizational efficiency, reprioritize resources and reduce cost.

Identifying weak connections involves detecting situations in which one or a small group of users are the only means of connection between an inside group and an outside group. This means that only a small number of people carry the connection which could point to a risk in losing the connection. To identify such weak connections, the pattern identification engine 250 may utilize different mechanisms. In an example, identifying a weak connection in an inside group is done by comparing the number of users in the inside group that are connected to the users in the outside group to a static threshold. The static threshold may be predetermined. In some implementations, the static threshold is situation dependent and can be set by a user. This identifies a risk when the number of users in an inside group that are connected to (e.g., engaged with) users in the outside group is smaller than the static threshold (e.g., less than 3 users in the inside group are connected to users in the outside group). In another example, identifying a weak connection is achieved by comparing the number of users in the inside group that are connected to users in the outside group to a normalized threshold value. The normalized threshold value may be determined by measuring the average number of users that are connected in each inside group to users of the outside group. For example, the average number of users in each inside group that are connected to users of an outside group may be 2. In that case, the threshold value used to identify weak connections is 2 instead of a static value such as 3, such that when 2 users in an inside group are connected to users in an outside group, a weak connection is not identified. In some implementations, in addition to the number of connected users, the strength of connections is also considered. Thus, the normalized threshold value may not only represent the average number of inside users that are connected to outside users but also the average strength of their connections. In other implementations, weak connections are identified by a model threshold value. The model threshold value may be determined based on relationships that are identified as being ideal. For example, when the first enterprise has a satisfactory relationship with a known second enterprise, the second enterprise may be identified as being a model relationship and used to derive values for the threshold used to identify weak connections. It should be noted that while numbers of users were discussed as being the threshold value, in some cases, percentages are used instead of number of users. For example, a static threshold value may indicate that there is a weak connection, when less than 10% of users in the inside group are connected with the users of the outside group. The process of identifying weak connections may involve analyzing relationships between each inside group and each outside group.

In some implementation, change over time in the number of users in each inside group that are connected to users of an outside group is also analyzed. For example, the pattern identification engine 250 may examine the number of users in an inside group who are connected to users of an outside group and detect that the number is suddenly decreasing. This may indicate a potential risk and/or point to an area of concern, which can indicate the need to investigate further and potentially reallocate resources to improve relationships.

The pattern identification engine 250 also identifies imbalances by detecting that there are unequally distributed connections between the users in the inside group. This may involve uses of one or more ML models such as the pattern identification models 252. The pattern identification engine 250 may also perform a centrality analysis to identify the most connected nodes in the connection graph. This is achieved by utilizing graph centrality measures and may involve use of the pattern identification models 252.

In addition to identifying weak connections in the inside groups, the pattern identification engine 250 also identifies weak connections in the outside groups. This involves detecting situations in which only a small group of users in a larger outside group are connected to users of an inside group. This may occur when there is only one user or a small group of users in an outside group that the users of an inside group connect with. This can become a potential risk and as such should be identified as a potential to improve connections. Identifying weak connections in the outside group can be done in a similar manner to identifying weak connections in the inside group by utilizing any of the above-discussed mechanisms for identifying weak connections. In some cases, there is less data and/or edges in the outside group, and as such identifying weak connections in the outside group may be more difficult. In such cases, clustering methods or link prediction can be used to improve the analysis.

In some implementations, the pattern identification engine 250 also identifies sparsity between the inside and outside groups. For example, when a new user is detected for an outside group, the pattern identification engine 250 can identify the new user to help determine an opportunity to establish a relationship with the new user. In another example, the pattern identification engine 240 identifies a user who is not sufficiently connected to users of an outside group. Sparsity can be detected by examining the connection graph to determine if a new vertex appears in an outside group or detect that a well-connected vertex disappeared from an inside group to an outside group.

The pattern identification engine 250 may also identify alternative paths for reaching people in an outside group. In some implementations, this is achieved by finding the shortest indirect connections to the users of the outside group via existing connections between the inside groups and the outside groups. This may be achieved by performing a centrality analysis to find the most connected people in the outside group and then finding alternative connections between those people and people in the inside groups. In other implementations, identifying alternative paths for reaching people in an outside group is done by identifying the shortest path and/or Geodesic distance to a vertex. This can be achieved by finding the shortest and nearly shortest path nodes in large substantially incomplete networks by hyperbolic mapping. This may involve use of the pattern identification models 252.

In some implementations, the pattern identification engine 250 also analyzes changes in connection patterns over time. This includes detecting decreased and/or increased connections with an outside group. Decreased connection may indicate that the first enterprise is becoming less relevant to the outside group, while increased connection may indicate a new opportunity for sale and/or a new issue that is causing more engagement. Increased and/or decreased connections are detected by measuring graph density (e.g., percentage of connections) which may be determined by measuring the number edges present between different nodes and comparing the graph density values to historical values or categorical averages to identify changes. In some implementations, edge weights are also measured and used in detecting increased/decreased connections. Edge weights are measured by measuring the frequency and length of connections, time of last contact, size of shared meetings and the like.

The pattern identification engine 250 may also detect changes over time in the types of engagements between groups. For example, the pattern identification engine 250 may detect an inside group is engaging in less in-person meetings with an outside group and instead has more virtual meetings. This is achieved by categorizing connections by the type of connection (e.g., call, chat, email, video call, in-person meeting, email, etc.) and provides weights the connection type based on the depth of connection. For example, in-person meetings are given more weight than emails to a small group of users. Chats are given less weight than in-person meetings and emails, while phone calls are given more weight than emails and chats. The types of connections with their given weights are then measured over time and compared to identify substantial increases/decreases in connections.

Additionally, the pattern identification engine 250 can detect that the level of engagement between an inside group and outside group is different from the level of engagement between other inside and outside groups. For example, the pattern identification engine 250 determines that the weak connections, connection levels, connection types, and the like for an inside group/outside group pair are different from the overall weak connections, connection levels, and connection types. This may be achieved by analyzing the level of connection via examining graph densities, analyzing connection type via examining the source of data and examining connection weight by measuring edge weights.

Once the pattern identification engine 250 has identified all required/needed patterns and data points, the identified data is transmitted to the recommendation engine 260 for processing. This may be achieved by utilizing one or more trained action identification models 262 that are trained to receive connection patterns, connection data and/or contextual data related to the first and/or the second enterprise as inputs, and generate recommended actions based on examining the input data. The types of recommendations and the manner in which they are provided to users depend on the types of patterns detected in the connection graph and/or the needs of the enterprise. An example of a detected pattern is when a user of an inside group is detected as being a primary connection for the second enterprise or for an important outside group in the second enterprise, or the user is detected as improving his connections with the second enterprise over time. This may lead to a notification being generated about the user's significance to the first enterprise. This notification may be transmitted to the user's manager and/or human resource (HR) department indicating to the responsible team that the user is an important asset for the first enterprise and should be retained. Detecting individuals with strong and/or weak connections can also help in making an informed decision regarding customer success. For example, upon identifying an employee with a strong connection to a customer, a recommendation may be made to use the individual to increase trust or credibility of the enterprise. In another example, detecting individuals with strong/weak connections can lead to recommendations for prioritizing meeting attendees based on the strength of their connections. The detections can also lead to recommendations for creating suitable mentoring opportunities such as matching well-connected individuals with less connected individuals. Furthermore, one or more ML models can be used to analyze the effects of connections on the enterprise's effectiveness and/or impact retrospectively, in order to improve training and strategy in the future. Moreover, detecting a weak connection may lead to a recommendation or a decision that the account/client should be prioritized so resources could be used effectively.

In some implementations, in addition to providing recommended actions and notifications, the action identification models 262 also provide data about the user who should be notified. For example, the action identification models 262 may determine that the user's manager should be notified when the recommendation is about retaining or promoting the employee. In another example, the action identification models 262 detects that an employee is only connected to a few outside group users and recommends that the employee's workload or contacts be spread out. This recommendation may be transmitted to the employee's manager.

In some implementations, the action identification models 262 receive inputs indicating that the overcall connection with the second enterprise, with an outside group within the second enterprise and/or with a specific user of the second enterprise is decreasing and generates a notification about the decreasing connection. This notification may be transmitted to an account team of the first enterprise which is in charge of the second enterprise or may be transmitted to a management team of the first enterprise, depending on the structure and the needs of the first enterprise. Detection of a decrease in connection may also be used to generate a notification that the connection should be examined to detect if there are deeper issues that need to be investigated (e.g., managerial change). In another example, the action identification models 262 receive connection data indicating that the overall connection with the second enterprise or with an outside group of the second enterprise is increasing and generates a notification for a business strategy team to notify them of the changing pattern. The increase may indicate a business opportunity and can thus help the team determine if more resources should be allocated to that project or whether the team should be connected with other organizations for further opportunities.

In some implementations, the action identification models 262 identify missing connections between members of inside and outside groups and notify a manager of the inside group of the missing connections. In another example, the action identification models 262 identify a new connection between members of inside and outside groups and notify a manager of the new connection. In yet another example, based on missing connections and/or decreased connections, the action identification models 262 generate a recommendation for hiring new employees for specific departments or for reassignment of the staff to a different department to improve the new department's connection to an enterprise.

The action identification models 262 may also be used in selecting a hiring candidate from among interested candidates. For example, a candidate's professional network can be analyzed based on available information (e.g., LinkedIn data) to examine the candidate's connections with one or more second enterprises and generate a recommendation based on the candidate's connections (e.g., a candidate would broaden the enterprise's connections, a candidate has deep relationships with high priority users within the second enterprise or with other high priority clients, or a candidate does not have any useful connections).

In other examples, the action identification models 262 examine the connection patterns of the connection graph and recommend potential paths and/or connections to reach a second-degree connection. Such a recommendation can be sent to the sales team or another team responsible for managing the connection. For example, before meeting with a client, the sales team utilizes the system to identify past (or lost) connections and tries to rekindle them to gain trust and understanding of the client. In another example, before the meeting, the sales team uses the enterprise connection analysis system 114 to identify partners (e.g., individuals or groups) that can be brought to the meeting to help close a deal. In other instances, the action identification models 262 identify a new contact in an outside group, identify users in the first enterprise who may have a way to make a connection with the new contact and/or generate and send recommendations for connecting with the new contact.

The action identification models 262 may also be used in identifying individuals that should be invited to a meeting or to speak at an event. In an example, when there is an issue that needs to be addressed, the enterprise connection analysis system 114 can be used to identify individuals/teams that can address the issue. For example, when there is an issue with a client, the system can be used to identify a neutral individual (e.g., not associated with the issue) who is well-connected with the client and/or internally to diffuse the situation. In another example, when there are two candidates for speaking at an event, the enterprise connection analysis system 114 can be used to analyze the connections of both candidates and determine which candidate has stronger connections with the even attendees/clients to prioritize the more connected candidate for the speaking role. As mentioned before, the type of recommendation generated may depend on the context of the enterprises as well as the types of connection patterns identified. Context of an enterprise may be derived via contextual data which is provided as part of the first enterprise data 210 and/or second enterprise data 220. Contextual data includes goals and objectives of the enterprise (e.g., improve sales, strengthen relationship with another enterprise, improve employee retention, reduce the number of employees, reduce costs, etc.), relevance of certain individuals and/or groups to the enterprise, importance of certain projects or products to the enterprise and the like. As an example, when an objective of the first enterprise is to have stronger connections with the second enterprise, this objective may be provided to the application and in turn transmitted to the action identification models 262, which uses the objective to generate a notification for a well-connected user within the first enterprise to introduce more members of his/her inside group to outside group members.

In some implementations, the notifications and recommendations are generated and transmitted automatically. For example, the enterprise connection analysis system 114 analyzes the latest connections based on a set schedule (e.g., once a day) and sends recommendations based on the latest data to relevant users. In other implementations, a user is able to transmit a request for certain recommendations or run certain reports. For example, a sales leader can run a weak connection report that identifies which high priority accounts have weak connections that need attention (e.g., which accounts can use seller diversification). In another example, a user can request that a communications risk evaluation be performed. In response, a list of potentially weak connection risks may be displayed to the user. The user can utilize the data to increase the number of sellers allocated to an account or encourage existing sales team to work on an account jointly. In yet another example, a sales leader can run a report that identifies weak connections in an outside enterprise (e.g., only a minority of users in the second enterprise are connected to users in the first enterprise). The sales leader can then use the data to determine how to improve connections with the second enterprise. In some implementations, the users can submit a request to review an analysis of overall enterprise-to-enterprise connections, inside group to outside group connections and/or individuals with the first enterprise to individuals within the second enterprise connections. When a user submits a request for an analysis, report or recommendation, the recommendation 270, which is generated by the recommendation engine 260 (e.g., via the action identification models 262) is transmitted back to the application from which the request was transmitted and displayed on the GUI screen of the application.

In some implementations, the enterprise connection analysis system 114 automatically analyses enterprise-to-enterprise connection data and generates recommendations (e.g., based on a predetermined schedule). For example, the enterprise connection analysis system 114 runs at predetermined time periods and analyzes the latest data. When recommendations are generated automatically, they may be transmitted to relevant users via a variety of mechanism. For example, an email message may be automatically generated and sent to the manager, sales leader, and the like. In another example, an-in app notification, desktop notification or instant message is automatically sent. A user may be able to select the manner and frequency with which they desire to receive notifications. In some implementations, the users can provide feedback regarding the recommendations. These feedbacks are collected and used in finetuning the models.

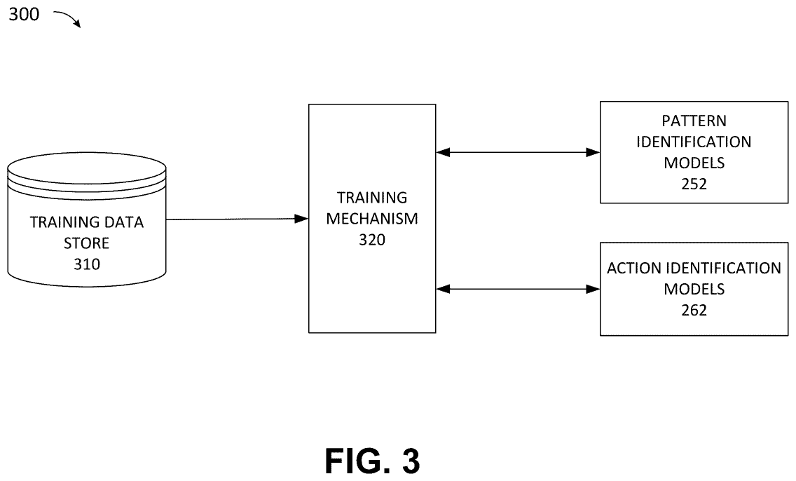

FIG. 3 depicts how one or more ML models used by the enterprise connection analysis system 114 are trained. In some implementations, one or more ML models implemented by enterprise connection analysis system 114 are trained by the training mechanism 320. The training mechanism 320 uses training datasets stored in the data store 310 to provide initial and ongoing training for each of the models. Alternatively, or additionally, the training mechanism 320 may use training data sets from elsewhere. In some implementations, the training mechanism 320 uses labeled training data to train one or more of the models via deep neural network(s) or other types of ML models. The initial training may be performed in an offline stage. Additionally, and/or alternatively, the one or more ML models may be trained using batch learning. While only one training mechanism 320 is shown, in practice, a different training mechanism may be used for each different ML model.

In some implementations, a training dataset which includes labeled connection graph data and corresponding identified connection patterns is used to train the pattern identification models 252. The action identification models 262 may be trained using labeled data created for training models for generating enterprise-to-enterprise connection recommendations. The data may be labeled by creating labels for outputs of the pattern identification models 252.

In some implementations, to provide ongoing training, the training mechanism 320 uses training data sets received from the ML models. Furthermore, data may be provided from the training mechanism 320 to the data store 310 to update one or more of the training datasets in order to provide updated and ongoing training. Additionally, the training mechanism 320 may receive training data such as knowledge from other pre-trained mechanisms. Moreover, previously generated connection graphs may be stored and updated as new data is received. The previously stored graphs may be used to provide updated/ongoing training to reduce training time and/or resources.

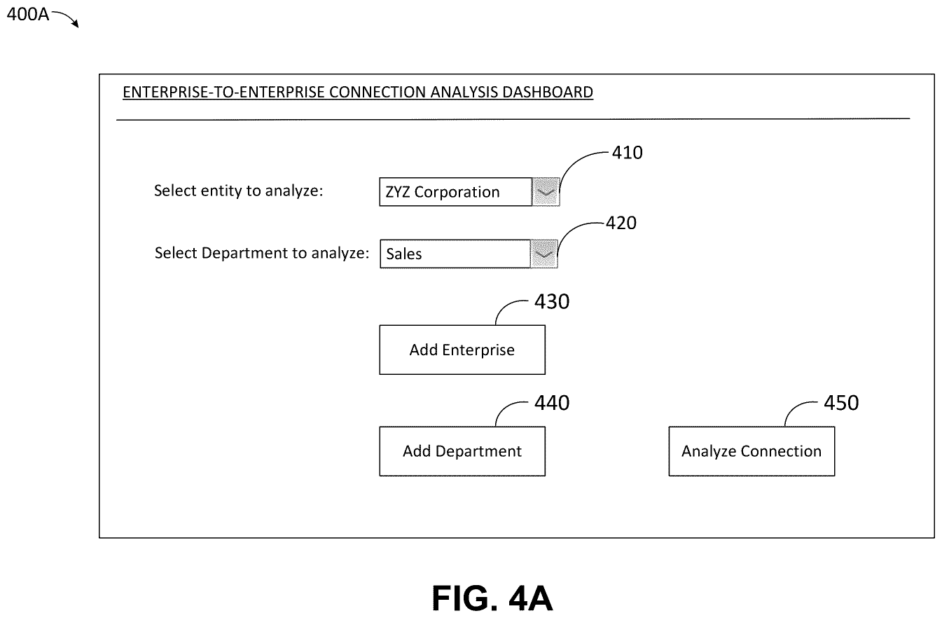

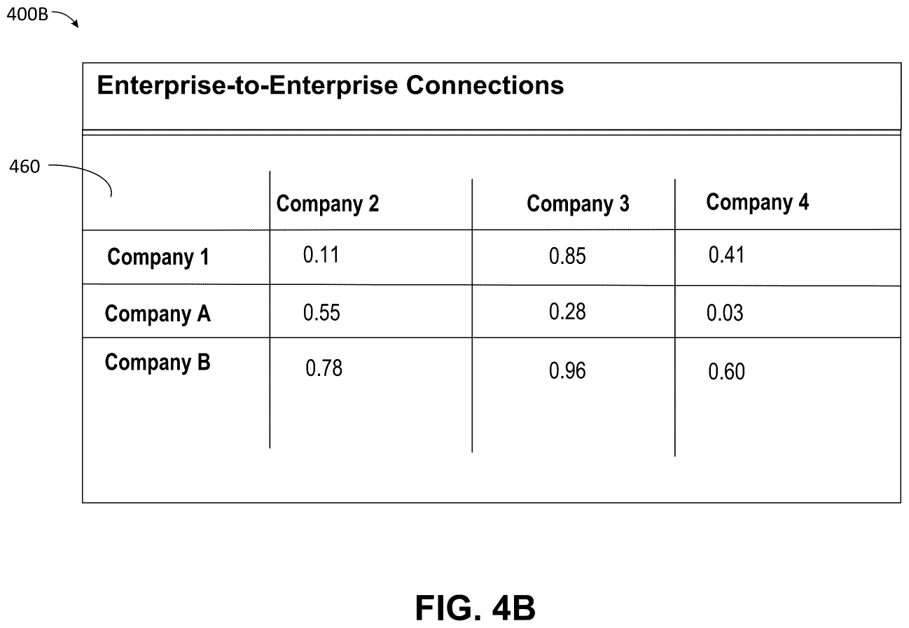

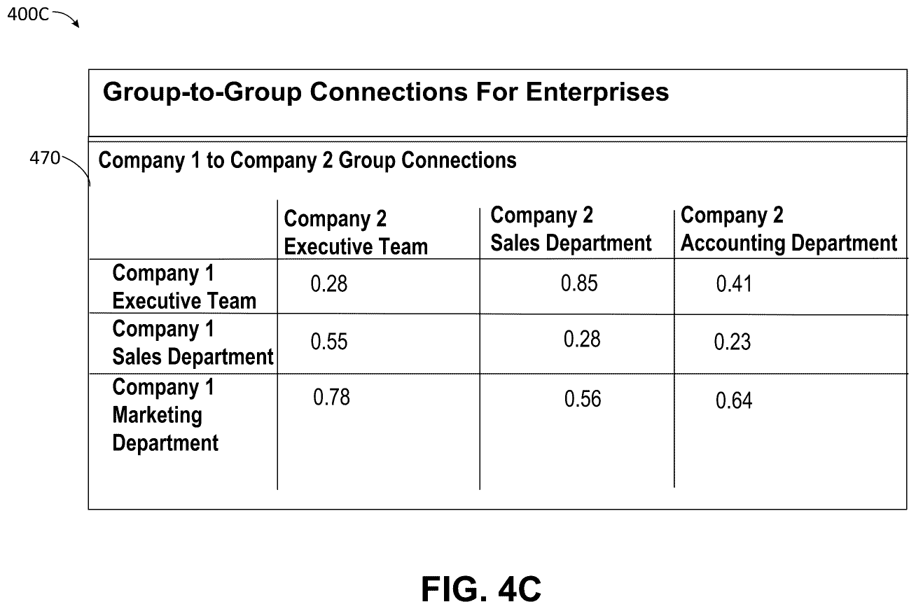

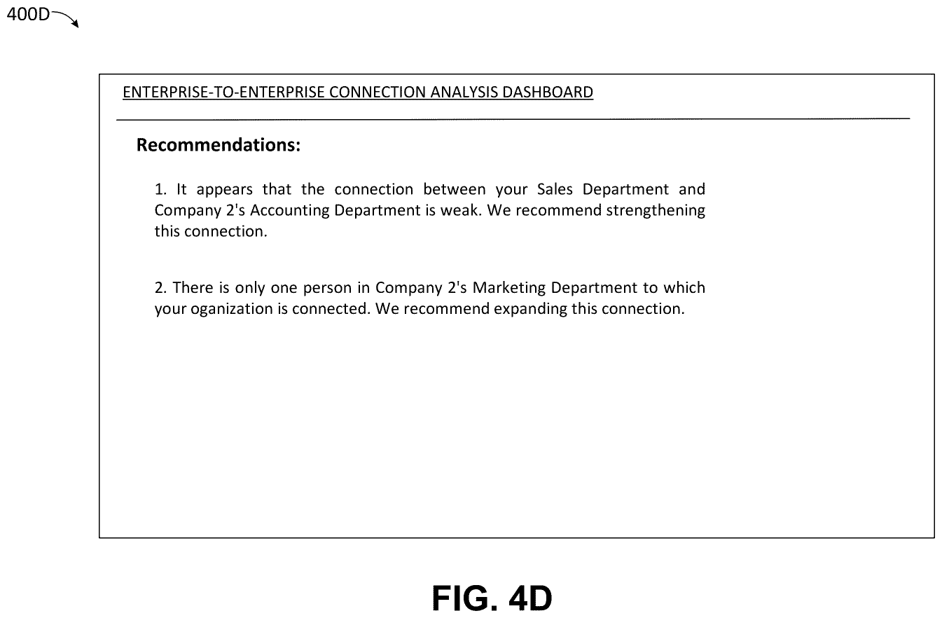

FIGS. 4A-4D depict example GUI screens of an application or service that offers review and analysis of enterprise-to-enterprise connections and/or providing recommendations for improving enterprise-to-enterprise connections. In some implementations, the GUI screen of a connection analysis and review application or service may include a plurality of UI menu options for selecting enterprises, groups within an enterprise and/or different types of reports and requests for submission. The UI options may include a UI element 410 for selecting a first enterprise to analyze connections with. This may be done by using a dropdown menu item such as the UI element 410 which includes a list of enterprises to which a first enterprise is connected. In some implementations, the user is able to enter enterprise names via an input box. In some implementations, a UI element is also included to select an enterprise to analyze the connections with respect to (i.e., the first enterprise). This is included in implementations, in which the first enterprise is not already clear or in which an enterprise can analyze connections between two other connections. It should be noted that this is only possible using data that is publicly available or otherwise legally available to the organization running the analysis.

Once the enterprises are selected, the user can utilize the UI element 420 to select an inside group and/or outside group for analysis. While FIG. 4A only displays one UI element 420, in some implementations, multiple UI elements are available for selecting a group within each organization that is selected for analysis. Additionally, the user can utilize the UI element 430 for adding another enterprise for analysis and the user can use the UI element 440 for adding another department for analysis. Other UI elements may also be included for adding additional filters and parameters for analysis. In some implementations, UI elements are available for entering goals and/or objectives for the first enterprise or additional information that should be taken into consideration about the first enterprise or the second enterprise. In further implementations, the user can select the type of analysis and/or reporting the user wishes to perform. Once all the selections have been made, the user can utilize the UI element 450 to initiate analysis of the connection.

In some implementations, the resulting analysis is displayed in a table such as the table 460 of a GUI screen such as the GUI screen 400B of FIG. 4B. The table 460 includes a trending topic information portion 440 for displaying information about the trending topics. The information may include a list of first enterprises (i.e., Company 1, Company A and Company B) and a list of second enterprises (e.g., Company 2, Company 3 and Company 4). For each enterprise-to-enterprise connection, the table 460 displays a value of a measurement parameter that measures the strength of the overall connection between the two enterprises. For example, for the connection between Company 1 and Company 2, the value of the measurement parameter is 0.11. This parameter may be measured based on a measurement of connections between users of the two enterprises. Connections between individuals may be measured based on a variety of parameters that include the number of connections between each user of the first enterprise and users of the second enterprise, the strength of the connections (e.g., the frequency and types of connections) and/or weighing parameters that are based on relevance and importance of different departments and individuals. The overall measurement value provides an overview of the strength of the connection between two enterprises.

In some implementations, clicking on the value of the measurement parameter in table 460 results in displaying a more detailed overview of the connection between the two enterprises represented by the measurement parameter. An example of such an overview is displayed in the GUI screen 400C of FIG. 4C which depicts a table 470. The table 470 includes a list of departments (e.g., groups) for each of the first and second enterprises. For example, the table 470 displays an executive team, sales department and accounting department for company 2 in each column and an executive team, sales department and marketing team in each row for company 1. Then a value for a measurement parameter that measures the strength of the connection between each inside group and outside group is displayed for each inside group/outside group pair. For example, table 470 displays that the strength of the connection between the marking department of Company 1 and executive team of Company 2 is 0.78. This indicates that there is a strong connection between the marking department of Company 1 and the executive team of Company 2. In some implementations, further information (e.g., deeper connections) can be explored by clicking on one of the values of the measured parameter in table 470. For example, clicking on the measurement parameter for the connection between the executive teams of Company 1 and Company 2 results in the display of another table that depicts a measurement value for the strength of the connections between the individual users in the executive teams of Company 1 and Company 2. In this manner, a user is able to explore deeper levels of connections to gain more insights about the level of connections between the two enterprises, as needed. It should be noted that access to any information regarding the connections between two or more enterprises is only made available to users who are authorized to access such information (e.g., who have access rights to such information). In making the information available to users, privacy guidelines and regulations are considered and taken into account.

FIG. 4D depicts a GUI screen 400D of an application or service that provides a list of one or more recommendations based on the connection analysis. For example, as depicted, the system may determine, based on the analysis, that connections between two important departments is weak and provide a recommendation for strengthening the connection. Moreover, the system may identify weak links between the connections, such as when only one person in a department is connected to the first enterprise and recommend strengthening the connection in those areas. While the recommendations on GUI screen 400B are displayed on one UI screen, in other implementations, separate recommendations are shown via different UI elements. For example, in-app notifications or desk top notifications may be utilized to provide individual recommendations.

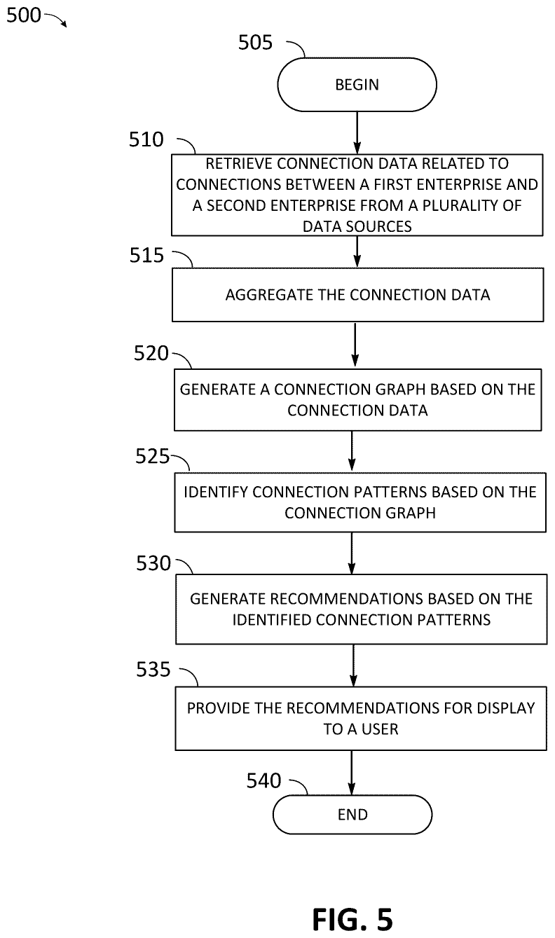

FIG. 5 is a flow diagram depicting an example method 500 for analyzing connections between two enterprises and providing recommendations based on the analysis. One or more steps of the method 500 may be performed by a system such as the enterprise connection analysis system 114 of FIGS. 1-2 or by an application such as applications 116/124/164A of FIG. 1.

The method 500 begins, at 505, and proceeds to retrieving connection data from a plurality of data sources, at 510. This may occur, for example, based on a predetermine schedule (e.g., based on a predetermine time frequency such as every 24 hours) or it may occur as a result of a user request. The data sources may be data sources that store connection data between the first enterprise and the second enterprise, contextual data about the first enterprise or contextual data about the second enterprise. The data sources may include communications data sources (emails, instant message, call logs, meeting data), social media data sources, professional network data source, organizational data sources (e.g., organization graph data), and the like. The data may be retrieved for a specific time period (e.g., since the last time data was retrieved).

Once the connection data is retrieved, method 500 proceeds to aggregate the retrieved data, at 515. This may be done to standardize the data (e.g., convert the data into the same schema). Standardization/normalization may use baseline signals from past communications within different groups or pairs of groups. In some implementations, aggregation includes identifying users associated with the first enterprise and the second enterprise. This may be achieved by using organization data for the first enterprise and publicly available information for the second enterprise (e.g., when user data for the second enterprise is not available). The identified users are then categorized into inside groups for the first enterprise and outside groups for the second enterprise. The inside groups may be determined based on a number of factors such as internal teams, departments, organizational structure and/or connection data. The outside groups may be identified based on available information such as professional network information that identifies user's role withing the second organization.

Once the connection data has been aggregated, method 500 proceeds to generate a connection graph based on the connection data using a connection graph generating engine, at 520. In some implementations, this involves generating a connection graph that depicts connections between one or more of the inside groups and one or more of the outside groups. Method 500 then proceeds, at 525, to identify connection patterns based on the generated connection graph. This may involve using one or more ML models. Identifying connection patterns may also involve measuring a value for a measurement parameter that indicates the strength of the connection between the two enterprises, between the inside groups and outside groups and/or between individual users of the first enterprise and the second enterprise.

After the connection patterns are identified, the identified connection patterns are used to generate recommendations for improving the connections between the two enterprises, at 530. This may involve providing the identified connection patterns, contextual data related to the first enterprise and/or contextual data related to the second enterprise to a trained ML model to generate recommendations based on the input. The contextual data may include goals and objectives of the first enterprise, relevance of certain individuals and/or groups to the first enterprise, importance of certain projects or products to the first enterprise and the like.

Once the recommendations are generated, method 500 proceeds to provide the recommendations for display to a user, at 535, before method 500 ends at 540. This may involve sending a notification to the user that displays a specific recommendation. It may also involve displaying a table of data, a graph or other UI element that depicts measurement parameters and/or recommendations on a UI screen.

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as client devices, native application providers, web servers, server clusters, external services, and other servers. A representative hardware layer 604 includes a processing unit 606 and associated executable instructions 608. The executable instructions 608 represent executable instructions of the software architecture 602, including implementation of the methods, modules and so forth described herein.

The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular system. The applications 620 may use functions available via OS 614, libraries 616, frameworks 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine depicted in block diagram 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement methods or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760 and/or position components 762, among a wide array of other environmental sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 762 may include, for example, location sensors (for example, a Global Position System (GPS) receiver), altitude sensors (for example, an air pressure sensor from which altitude may be derived), and/or orientation sensors (for example, magnetometers). The motion components 758 may include, for example, motion sensors such as acceleration and rotation sensors. The environmental components 760 may include, for example, illumination sensors, acoustic sensors and/or temperature sensors.

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 764 such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-7) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the foregoing detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor, cause the data processing system to perform functions of:
aggregating connection data from a plurality of data sources, the connection data being related to connections between a first enterprise and a second enterprise;
utilizing a connection graph generating engine to generate a connection graph for the connections between the first enterprise and the second enterprise, the connection graph being generated based on the aggregated connection data;
providing the connection graph as an input to a first trained machine-learning (ML) model to identify connection patterns in the connections between the first enterprise and the second enterprise;
generating recommendations using a second trained ML model based on the identified connection patterns and based on at least one of a context of the first enterprise and a context of the second enterprise; and
providing the recommendations for display to a user.

2. The data processing system of claim 1, wherein the plurality of data sources include at least one of a communications data source, a social network data source, a professional network data source, a calendar data source and an organizational graph data source.

3. The data processing system of claim 1, wherein identifying connection patterns include identifying changes in communications patterns over time.

4. The data processing system of claim 1, wherein identifying the connection patterns include identifying at least one of weak connection areas between the first enterprise and the second enterprise and strong connection areas between the first enterprise and the second enterprise.

5. The data processing system of claim 1, wherein identifying the connection patterns include measuring a value for a measurement parameter that represents a strength of the connections between the first enterprise and the second enterprise.

6. The data processing system of claim 1, wherein aggregating the connection data includes categorizing users of the first enterprise into a plurality of inside groups and categorizing the users of the second enterprise into a plurality of outside groups.

7. The data processing system of claim 6, wherein identifying the connection patterns include identifying connection patterns between one or more of the plurality of inside groups and one or more of the plurality of outside groups.

8. The data processing system of claim 6, wherein identifying the connection patterns further includes measuring a value for a measurement parameter that represents a strength of the connections between the one or more of the plurality of inside groups and one or more of the plurality of outside groups.

9. A method for analyzing connections between a first enterprise and a second enterprise comprising:
retrieving connection data related to connections between the first enterprise and the second enterprise from a plurality of data sources;
utilizing a connection graph generating engine to generate a connection graph for the connections between the first enterprise and the second enterprise, the connection graph being generated based on the retrieved connection data;
providing the connection graph as an input to a first trained machine-learning (ML) model to identify connection patterns in the connections between the first enterprise and the second enterprise;
generate recommendations using a second trained ML model based on the identified connection patterns and based on at least one of a context of the first enterprise and a context of the second enterprise; and
providing the recommendations for display to a user.

10. The method of claim 9, further comprising aggregating the connection data from the plurality of data sources for use in generating the connection graph.

11. The method of claim 10, wherein aggregating the connection data includes:
identifying a plurality of first users in the first enterprise;
identifying a plurality of second users in the second enterprise;
categorizing the plurality of first users into a plurality of inside groups; and
categorizing the plurality of second users into a plurality of outside groups.

12. The method of claim 11, wherein identifying the connection patterns include identifying connection patterns between one or more of the plurality of inside groups and one or more of the plurality of outside groups.

13. The method of claim 12, wherein identifying the connection patterns further includes measuring a value for a measurement parameter that represents a strength of the connections between the one or more of the plurality of inside groups and one or more of the plurality of outside groups.

14. The method of claim 13, further comprising providing the value for the measurement parameter for display to the user.

15. The method of claim 9, wherein the context of the first enterprise includes at least one of an objective of the first enterprise, relevance of an individual or a group to the first enterprise, and relevance of a project or product to the first enterprise.

16. The method of claim 9, further comprising providing the value for the measurement parameter for display to the user.

17. A non-transitory computer readable medium on which are stored instructions that, when executed, cause a programmable device to perform functions of:
aggregating connection data from a plurality of data sources, the connection data being related to connections between a first enterprise and a second enterprise;
utilizing a connection graph generating engine to generate a connection graph for the connections between the first enterprise and the second enterprise, the connection graph being generated based on the aggregated connection data;
providing the connection graph as an input to a first trained machine-learning (ML) model to identify connection patterns in the connections between the first enterprise and the second enterprise;
training a second ML model to generate recommendations for improving the connections between the first enterprise and the second enterprise based on connection patterns between the first enterprise and the second enterprise;
utilizing the second trained ML model to generate the recommendations based on the identified connection patterns and based on at least one of a context of the first enterprise and a context of the second enterprise.

18. The non-transitory computer readable medium of claim 17, wherein the second ML model is trained using labeled training data to receive at least one of connection patterns between two enterprises and contextual data related to at least one of the two enterprises and provide recommendations for improving the connection between the two enterprises as an output.

19. The non-transitory computer readable medium of claim 17, wherein the instructions when executed, further cause the programmable device to train the first trained ML model to receive a connection graph of connections between two enterprises as an output and identify connection patterns between the two enterprises as an output.

20. The non-transitory computer readable medium of claim 17, wherein the connection graph is generated using a third ML model.
